(19) United States
(12) Patent Application Publication
(10) Pub. No.: US 2018/0105312 A1
(43) Pub. Date: Apr. 19, 2018

(54) METHOD FOR MAKING A CONTAINMENT ELEMENT AND APPARATUS FOR HEAT-SEALING A COVERING FILM TO AN ANNULAR BAND OF A CONTAINMENT ELEMENT

(71) Applicant: IMMOBILIARE MONDINI S.P.A., 25122 BRESCIA (IT)

(72) Inventor: GIOVANNI MONDINI, COLOGNE (IT)

(21) Appl. No.: 15/785,948

(22) Filed: Oct. 17, 2017

(30) Foreign Application Priority Data
Oct. 19, 2016 (IT) 102016000105165
Apr. 14, 2017 (IT) 102017000042066

(51) Int. Cl. B65D 1/28; B29C 51/32; B29C 51/36; B29C 51/02; B29C 51/14; B29C 51/42; B29C 51/30

(52) U.S. Cl. CPC B65D 1/28; B29C 51/325; B29C 51/36; B29C 51/306; B29C 51/14; B29C 51/428; B29C 51/02

(57) ABSTRACT

A method for making a containment element that has a bottom wall (3), a lateral wall (4) connected at the bottom to the bottom wall (3) and a shaped perimetric flange that extends outwards from an upper part of the lateral wall (4), wherein the method comprises a thermoforming operating step in which a flat sheet is thermoformed and the bottom wall (3), the lateral wall (4) and an annular band (2) that projects outwards from the upper part of the lateral wall (4) are created and, subsequently, a hot bending operating step for bending the annular band (2), dividing the annular band (2) into a first annular portion (6) and a second annular portion (7) which are concentric and are not coplanar, after the hot bending the annular band (2) constituting the shaped perimetric flange. An apparatus and a machine able to implement all or part of that method are also claimed.

This invention relates to a method for making a containment element, as well as an apparatus for heat-sealing a covering film to an annular band of a containment element.

Particularly in the food packaging sector, containment elements are used, which are obtained by thermoforming (usually with a vacuum), and have a basin or tray shape. They are closed at the top with a heat-sealable plastic film.

In general, containment elements therefore have a bottom wall and a lateral wall that extends upwards from the bottom wall. Extending outwards from the upper part of the lateral wall there is an annular band that forms an outline of the upper opening of the container, and to which the plastic film for closing the container is sealed.

At present, containment elements of this type may be divided into two types depending on the shape of the annular band.

In fact, a first type of containment elements has a flat annular band extending only in a horizontal plane.

In contrast, a second type of containment elements has an annular band that is constituted of a shaped flange, and on whose upper surface it is possible to identify at least two annular portions that are concentric and not coplanar.

In the first type of containment elements, the presence of a flat flange constitutes an element of mechanical weakness, that makes them unsuitable for uses that require some sturdiness.

In contrast, the containment elements of the second type, thanks to the presence of the shaped flange, their other characteristics being equal, can guarantee a mechanical sturdiness considerably greater than a containment element with a flat flange.

In many contexts, such as for example in the case of companies with small-scale production of many different products, it is possible that there are different packaging lines available, each intended for packaging the products in a different type of container, but only one container thermoforming line.

However, in these cases, the type of containment element produced by the thermoforming line is always the same for the subsequent packaging lines, despite this not necessarily being the best choice. In fact, in many cases, for the companies it would absolutely be preferable to be able to have available both types of containers, but the costs linked to purchasing and installing a double thermoforming line prevent it.

In this context the technical purpose which forms the basis of this invention is to provide a method for making a containment element which overcomes the above-mentioned disadvantages.

In particular, the technical purpose of this invention is to provide a method for making a containment element that guarantees a high degree of flexibility of choice in terms of the type of containment element to be made.

The technical purpose of this invention is also to provide an apparatus that allows easy implementation of that method.

The technical purpose specified and the aims indicated are substantially achieved by a making a containment element as described in the appended claims.

Further features and the advantages of this invention are more apparent in the detailed description, with reference to the accompanying drawings which illustrate several preferred, non-limiting embodiments of a method for making a containment element, in which:

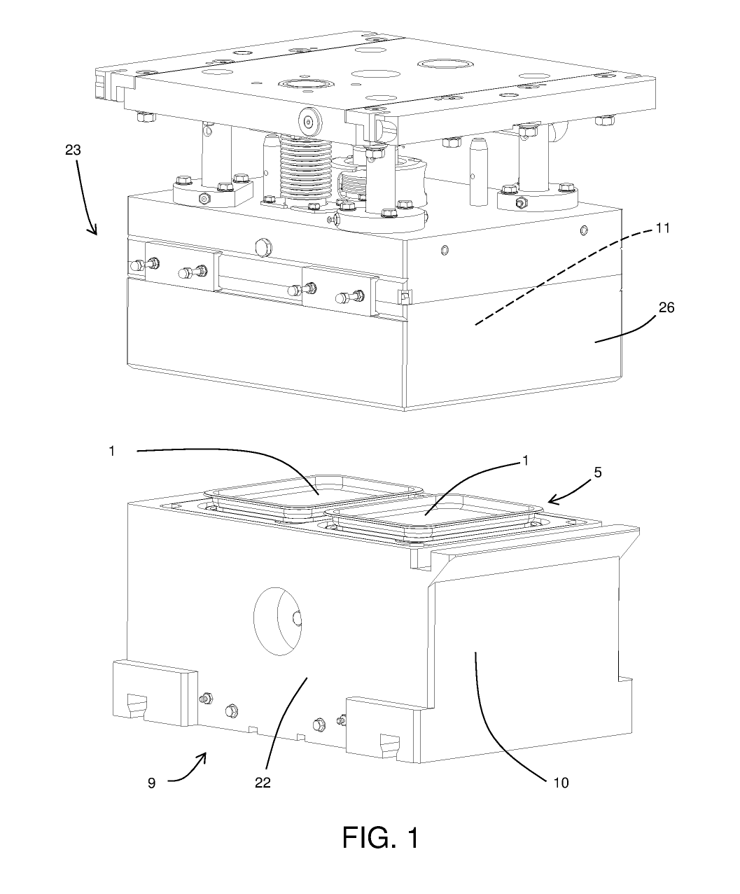

FIG. 1 is an axonometric three-quarter view of a part of an apparatus able to implement some steps of the method according to this invention, in an operating position corresponding to the end of implementation of the method;

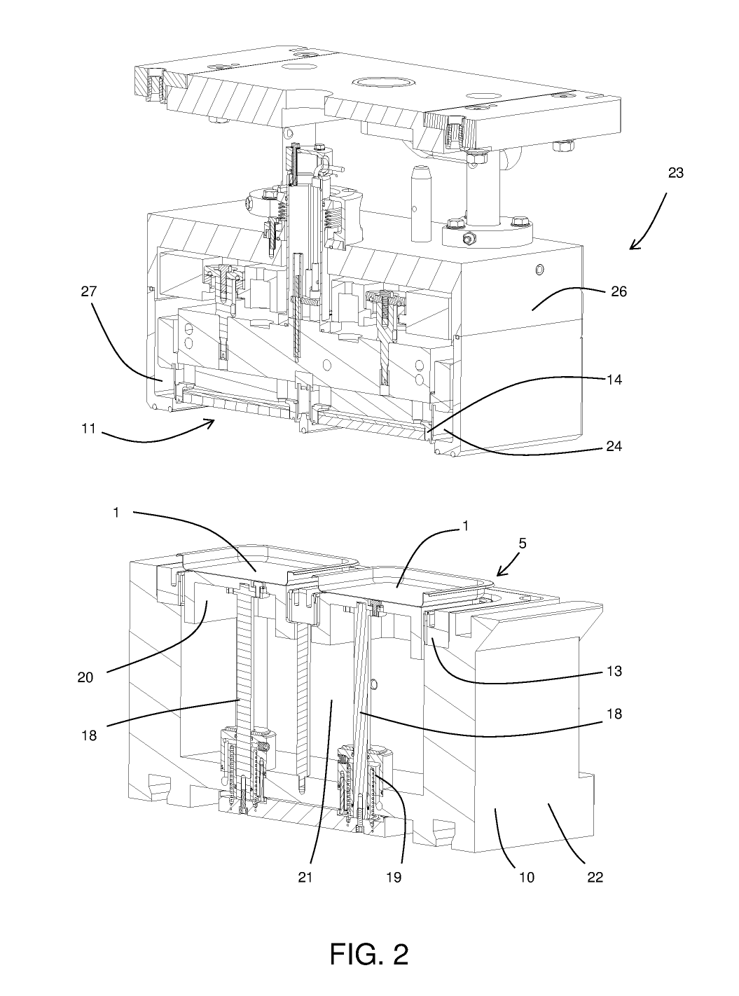

FIG. 2 is a vertical section of the part of the apparatus of FIG. 1;

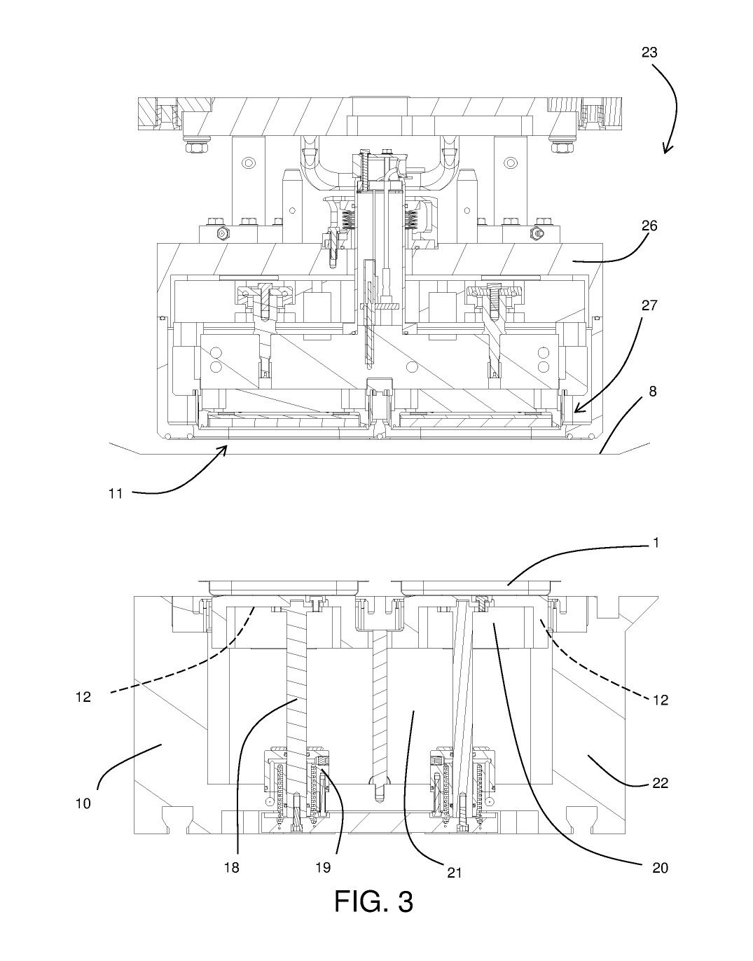

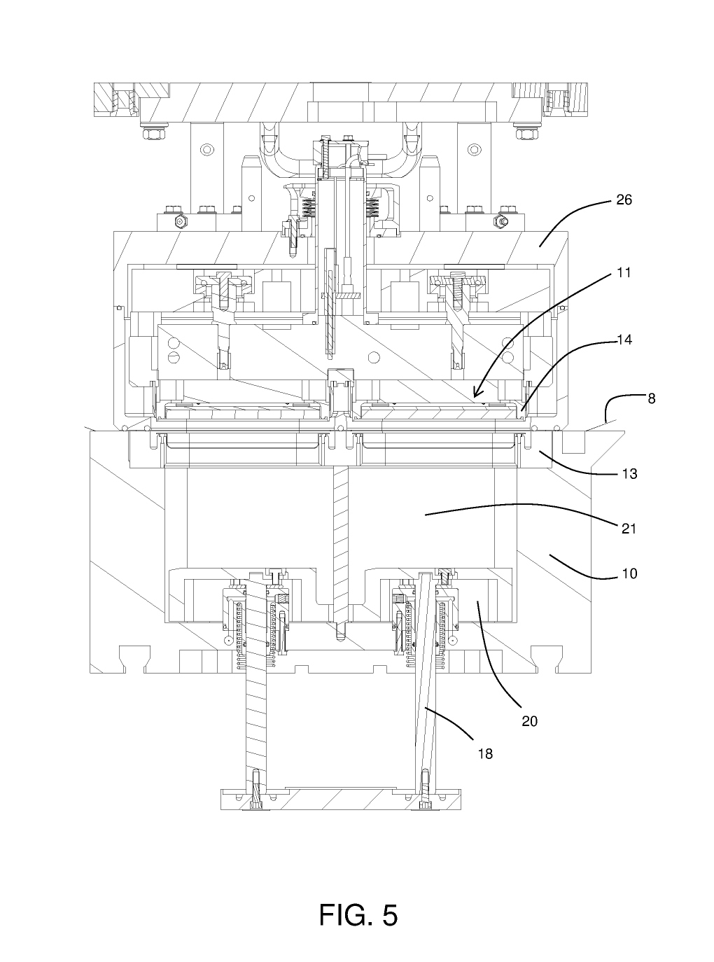

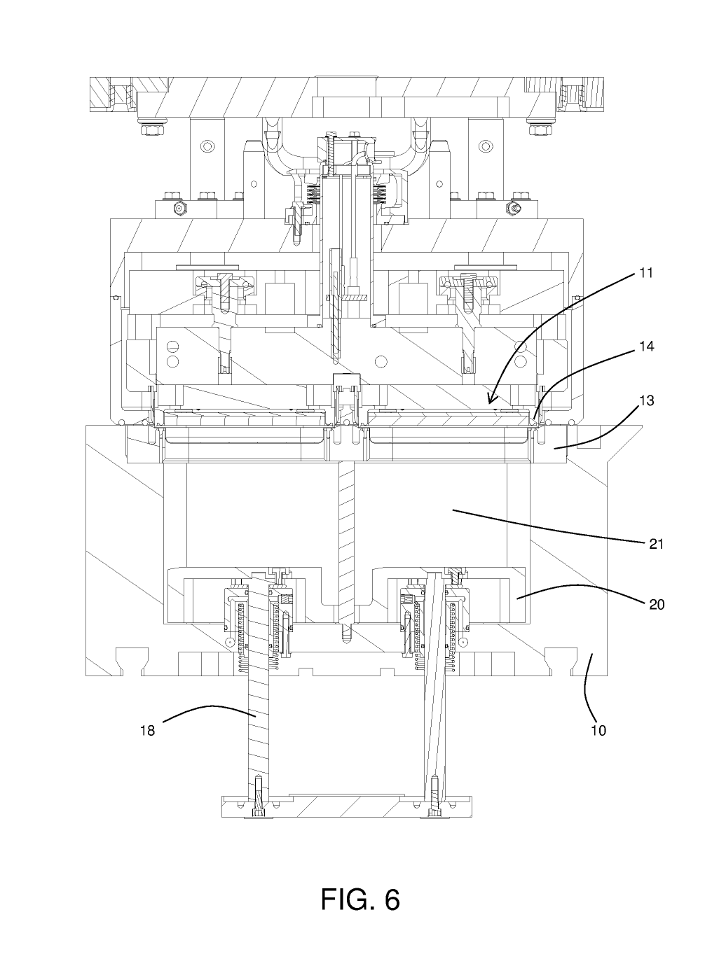

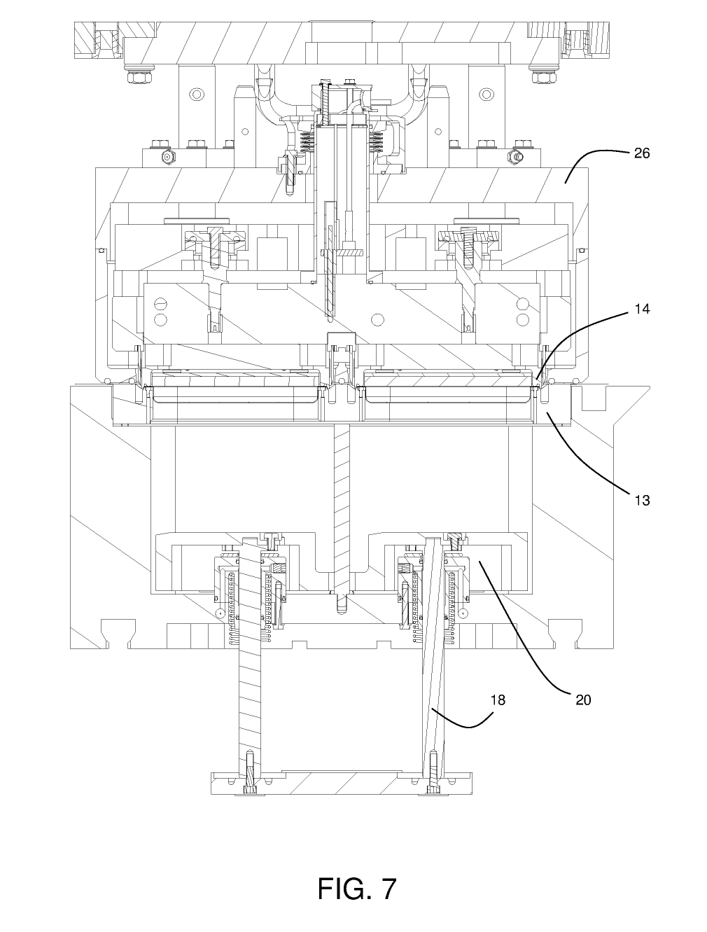

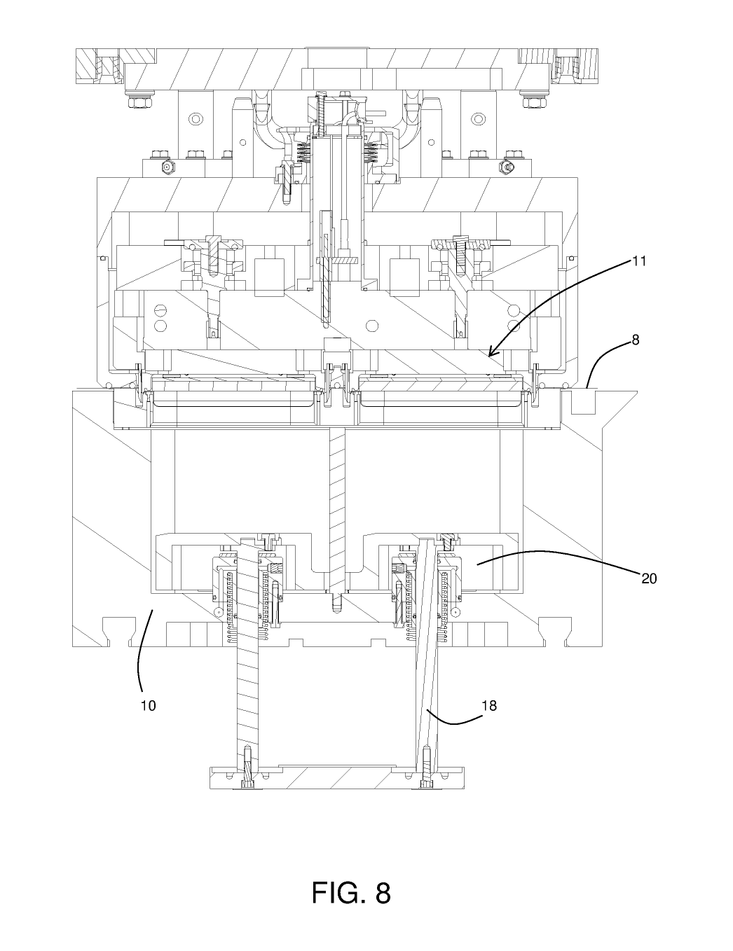

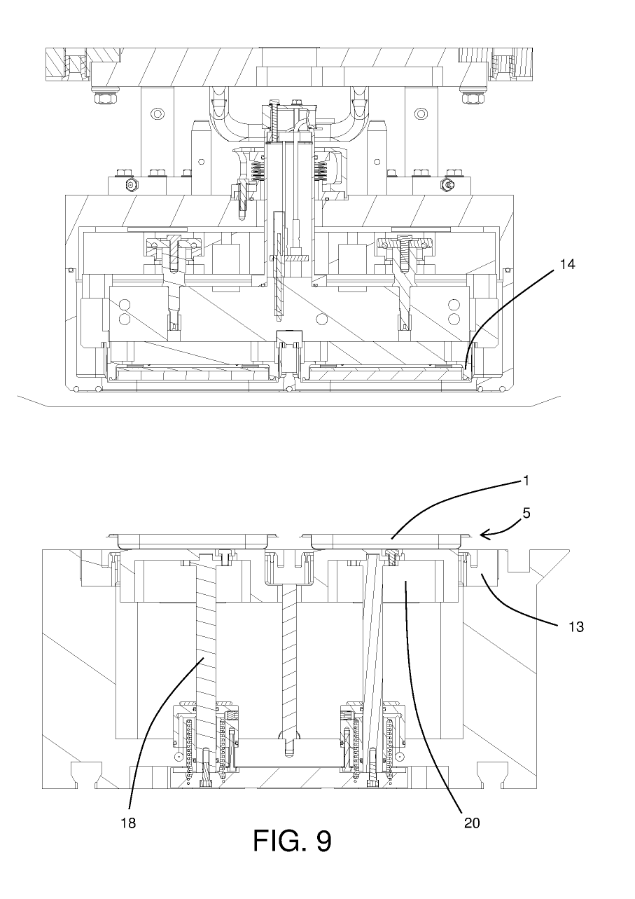

FIGS. 3 to 9 show the apparatus of FIG. 2 in six successive steps, during its use in accordance with a preferred embodiment of the method according to this invention;

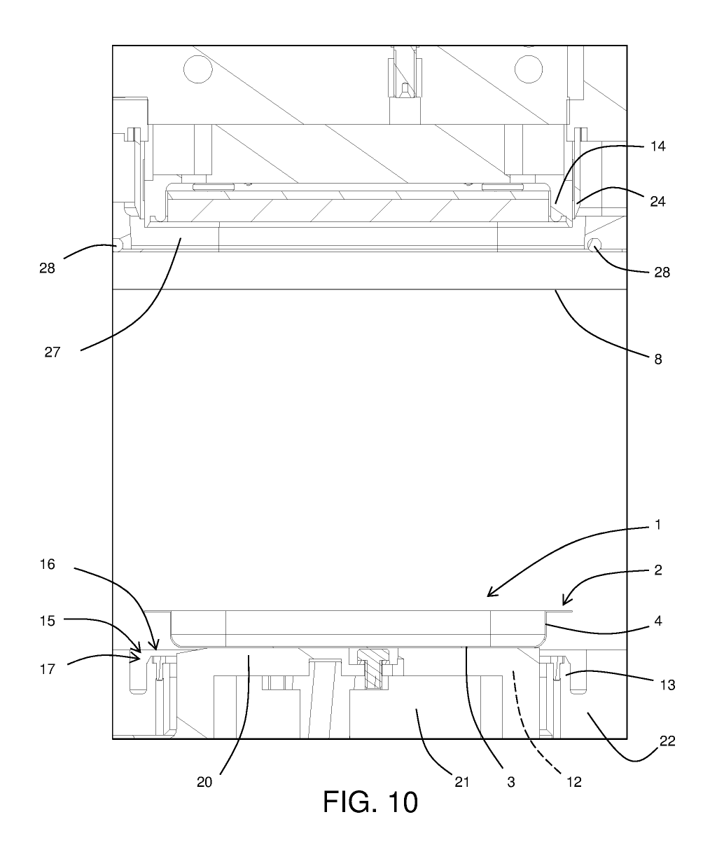

FIGS. 10 to 16 are enlarged views of the most significant part of each of FIGS. 3 to 9;

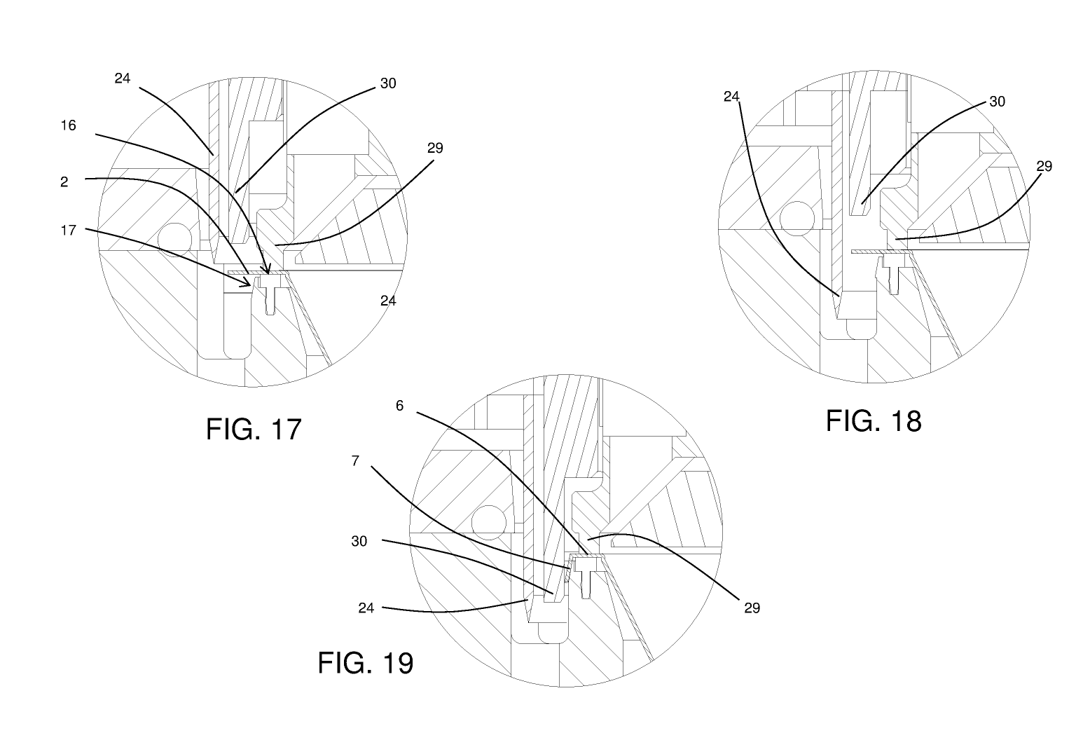

FIGS. 17 and 19 show, in two different reciprocal positions, several details of an alternative embodiment of this invention (without the covering film); and

FIG. 18 shows a further possible alternative embodiment relative to that illustrated in FIGS. 17 and 19 (without the covering film).

The following is a description first of the method according to this invention and then of a possible apparatus for implementing it. What is described below, respectively with reference to the method or to the apparatus, shall be understood to also be valid respectively for the apparatus or the method.

The innovative idea which forms the basis of this invention is that of making the containment elements 1 with a two-step process, in which if necessary the two steps may even be performed at different times.

In a first step, thermoforming is used to make a containment element 1 that is the same as the containment elements 1 of the first known type described above, that is to say, equipped with a flat annular band 2 that extends exclusively in a horizontal plane.

That containment element 1 may then be used as it is for applications requiring the use of a containment element 1 with a flat annular band 2, whilst it can be subjected to the second part of the method disclosed if use of a container in which the annular band 2 must be a shaped flange is required.

In this case, in fact, the container is subsequently subjected to a hot bending process localised at the annular band 2. That hot bending step may be implemented in any context necessary, and in particular either as an independent step on containers previously thermoformed even in another place, or as an optional additional step in a thermoforming plant, or, as in the preferred embodiment, simultaneously with sealing of the containment element 1 with a closing film.

Having said that, it is possible to move on to the detailed description of the most general embodiment of the method according to this invention. That method is intended for making a containment element 1 that has a bottom wall 3, a lateral wall 4 connected at the bottom to the bottom wall 3 and a shaped perimetric flange 5 that extends outwards from an upper part of the lateral wall 4.

The method comprises first an operating step of taking a flat sheet (not illustrated) constituted of a thermoformable material, followed by a thermoforming operating step in which the flat sheet is thermoformed and the bottom wall 3, the lateral wall 4 and an annular band 2 that projects outwards from the upper part of the lateral wall 4 are created.

Advantageously, this thermoforming operation is of the vacuum type, but other ways may be freely used.

Then, the method comprises a hot bending operating step, during which the annular band 2 is bent and thereby divided into a first annular portion 6 and a second annular portion 7 that are concentric, adjacent and not coplanar.

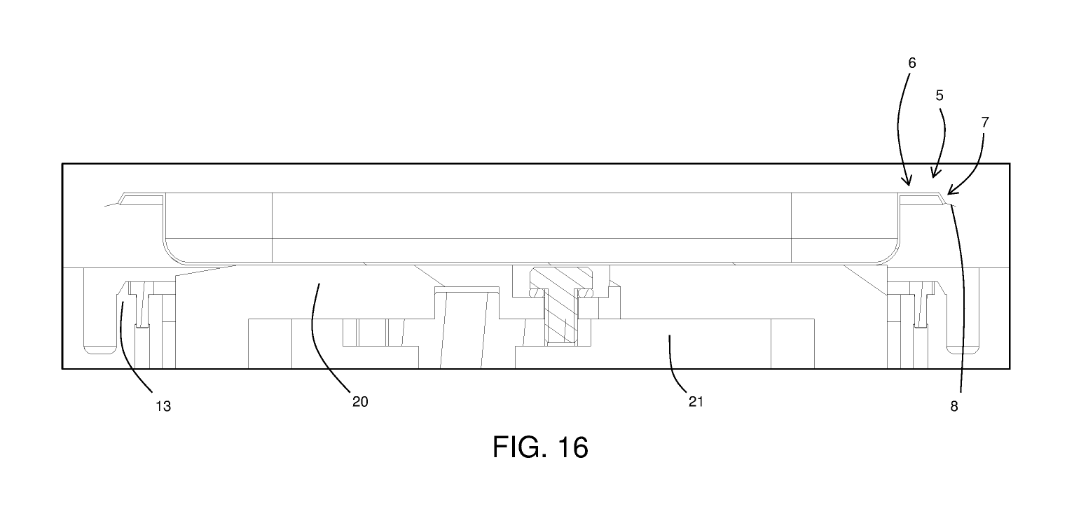

Depending on the embodiments, in vertical section the first annular portion 6 and the second annular portion 7 may be straight (as in FIG. 16) or curved. Furthermore, it may even be the case that during the hot bending step the annular band 2 is bent in such a way that it is divided into more than two concentric annular portions.

In any case, after the hot bending the annular band 2 constitutes the shaped perimetric flange.

As already indicated, in a particularly preferred but not exclusive embodiment of the method according to this invention, the hot bending step is performed at the same time as sealing of the containment element 1, that is to say, either simultaneously with it, or immediately after it or immediately before it.

In this case, after the thermoforming step, the method also comprises first an operating step of positioning a covering film 8 above the containment element 1, in such a way that a part of the covering film 8 rests on the annular band 2, at least for part of the outward extent of the annular band 2, relative to the upper part of the lateral wall 4. This may be achieved by spreading out a web of covering film 8 above the containment element 1 and cutting the web to form a closing element for the container after sealing (as in the case illustrated in the accompanying figures), or by preparing individual sheets of covering film 8 of the correct size and applying them to the containment element 1.

In order to combine sealing and the hot bending step, advantageously the later comprises an initial step of heating the annular band 2 of the containment element 1 and the part of the covering film 8 positioned on the annular band 2, a step of heat-sealing the covering film 8 to the annular band 2, and a step of mechanical hot bending of the annular band 2 (the latter two both performed after the covering film 8 and the annular band 2 have been heated). In general, the hot bending step may be performed either after the heat-sealing step, or simultaneously with the heat-sealing step or before the heat-sealing step, depending on requirements. However, in the preferred applications, the hot bending step is performed during the heat-sealing step, but it also begins a predetermined time after the moment when the heat-sealing step begins.

If the covering film 8 has not been previously cut into sheets of the correct size, the method may then comprise, after the thermoforming and heat-sealing steps, also a step of cutting the covering film 8 along a profile that surrounds the annular band 2.

Although the step of cutting the covering film 8 may be performed before or after the hot bending step, advantageously, it is usually performed before the hot bending step.

In its preferred embodiment, in which the hot bending step occurs at the same time as the sealing step for sealing the containment element 1, the method described above is generally part of a method for packaging products, in particular foodstuffs.

That packaging method, as well as comprising the operating step of making a containment element 1 according to the method described above, comprises a step of positioning the product to be packaged in the containment element 1, a step that is performed after the thermoforming operating step and before the hot bending operating step (which takes place at the same time as the sealing step).

If necessary, the packaging method may also comprise an operating step of creating a modified atmosphere in the containment element 1, a step that will be performed after the step of inserting the product in the containment element 1 and before the hot bending operating step.

In contrast, if the method according to this invention does not comprise the combination of the hot bending step with a step of sealing the containment element 1, the hot bending step advantageously comprises an initial step of heating only the annular band 2 of the containment element 1 followed by mechanical hot bending.

In some embodiments, it is even possible to use a single flat sheet of thermoformable material for thermoforming, during the thermoforming step, a plurality of containment elements 1 that are attached to each other at mutual outer edges of the annular bands 2. In this case, the method may then comprise a further step of separating the containment elements which may advantageously be performed by making a cut at the joined outer edges. If the method already comprises the step of cutting the covering film, the separating step may advantageously be performed at the same time as it. In contrast, if the covering film is not present or the method does not comprise its cutting, the separating step may be performed by means of an independent cutting step.

Moving on to the apparatus according to this invention, in a first preferred embodiment, it may be defined as an apparatus for heat-sealing a covering film 8 to an annular band 2 of a containment element 1. That apparatus is intended to allow simultaneous implementation of the operating steps of sealing of the containment element 1 and hot bending of the flat annular band 2 of a containment element 1 previously prepared. According to a second preferred embodiment, the apparatus may in contrast constitute a hot bending station (with optional activation depending on requirements) in a thermoforming machine. In both cases, the apparatus is therefore intended to perform only the final steps of the method, those that follow the thermoforming step, but in the latter case, the thermoforming machine of which the apparatus is a part is, overall, capable of implementing the entire method.

As illustrated in the accompanying figures, the core 9 of that apparatus comprises two main parts, a supporting base 10 (at the bottom in the accompanying figures) and a closing device 11 (at the top in the accompanying figures). The part of the apparatus illustrated in the accompanying figures is intended, intended, in particular, for simultaneously working on two containment elements 1, but in other embodiments there may be any number of containment elements 1. Since the operations on the two containment elements 1 are exactly the same, whilst FIGS. 3 to 9 show the core 9 of the apparatus as a whole, FIGS. 10 to 16 are enlarged views exclusively of the detail of what gradually occurs on a single containment element 1.

The supporting base 10 in turn comprises a housing seat 12 suitable for in use housing the bottom wall 3 and the lateral wall 4 of a containment element 1, and a first half-mould 13 that has an annular shape and that surrounds the housing seat 12. The first half-mould 13 is suitable for in use supporting the annular band 2 of a containment element 1 whose bottom wall 3 and lateral wall 4 are inserted in the housing seat 12.

The closing device 11 is positioned above the supporting base 10 and comprises at least a second half-mould 14 that has an annular shape and that is shaped to match the first half-mould 13, so that it can be coupled to the first half-mould and together with the first half-mould 13 form a mould with annular extension that is shaped liked the first annular portion 6 and the second annular portion 7 that are to be obtained in the annular band 2. In other words, at least one of either the first half-mould 13 or the second half-mould 14 (the first half-mould 13 in the accompanying figures—FIG. 10) has a moulding surface 15 that comprises at least a first annular zone 16 that in the operating position surrounds the housing seat 12 and a second annular zone 17 concentric with and adjacent to the first annular zone 16, the first annular zone 16 and the second annular zone 17 not being coplanar (the other half-mould—the second half-mould 14 in the accompanying figures—in contrast is at least partly shaped to match it).

At least one of either the supporting base 10 or the closing device 11 is movable relative to the other, between a home position in which the two are at a distance from one another, and an operating position in which the first half-mould 13 and the second half-mould 14 are coupled and can define the mould with annular extension suitable for in use clamping the annular band 2. In the embodiment illustrated, it is the supporting base 10 that moves the most and is slidably mounted on a plurality of fixed guiding columns 18, on which it slides thanks to suitable slides 19 mounted in a gastight way.

However, the final part of the mutual movement is obtained by a movement of the closing device 11 as described in more detail below.

However, there may be various embodiments as regards the structure of the two half-moulds 13, 14. In particular, as illustrated for example in FIGS. 10 to 16, both of the half-moulds 13, 14 may be rigid.

Alternatively, at least one of them may also comprise a first body 29 and a second body 30 that are annular and concentric, and the second body 30 may be telescopically movable relative to the first body 29, between a non-operating position and an operating position. When the second body 30 is in the operating position, the first half-mould 13 and the second half-mould 14 are couplable and can constitute the annular mould. In contrast, when the second body 30 is in the non-operating position, the first half-mould 13 and the second half-mould 14 cannot fully constitute the annular mould; in particular, if the first half-mould 13 and the second half-mould 14 are coupled, the mould that is obtained from them is not able to define at least one of either the first annular portion 6 or the second annular portion 7.

In the embodiments illustrated in FIGS. 17 to 19, the first body 29 and the second body 30 are part of the second half-mould 14. The first body 29 is mounted on the inside relative to the second body 30 and constitutes the part of the second half-mould 14 intended to interact with the first annular portion 6 and to perform sealing of the covering film 8, whilst the second body 30 is retracted relative to the resting surface defined by the first body 29 when it is in the non-operating position, and projects relative to it when it is in the operating position. Only in this latter position can the second body 30 interact with the first half-mould 13 for hot bending the second annular portion 7. In use, it may advantageously be the case that at the moment of closing of the annular mould the second body 30 is in the non-operating position and in this way, initially, only sealing of the covering film 8 is performed (FIG. 17). Only after a predetermined time is the second body 30 brought into the operating position for hot bending the second annular portion 7 (FIG. 19).

The supporting base 10 and the closing device 11 can be used on their own for implementing the second hot bending step independently of any subsequent step of sealing of the containment elements 1. Therefore, they are present on their own when the apparatus is part of a thermoforming machine. However, when the hot bending step has to be combined with the sealing step, the apparatus advantageously also comprises a retaining device that is operatively associated with the supporting base 10 and with the closing device 11 and that is suitable for in use retaining a covering film 8 interposed between the first half-mould 13 and the second half-mould 14. Since retaining devices of this type are in themselves known in normal sealing machines, they are not described in further detail herein, nor illustrated in the accompanying figures. The figures show a case in which a web of covering film 8 is used which is gradually unwound so that it can be retained by the retaining device in such a way that it is interposed between the supporting base 10 and the closing device 11.

In some embodiments, the supporting base 10 advantageously also comprises an insertion and extraction element 20 associated with the housing seat 12 for facilitating automatic insertion and extraction of the containment elements 1. At least one of either the housing seat 12 or the insertion and extraction element 20 is in fact movable relative to the other between an engaged position, in which the insertion and extraction element 20 prevents the insertion of a containment element 1 in the housing seat 12, and a disengaged position, in which the insertion and extraction element 20 allows the insertion of a containment element 1 in the housing seat 12. In the engaged position, a containment element 1 may advantageously be positioned at the housing seat 12 and extracted from the apparatus by means of a simple movement in a horizontal plane. In the embodiment illustrated, each insertion and extraction element 20 is fixed to the upper part of a guiding column 18. When the supporting base 10 and the closing device 11 are in the home position, the insertion and extraction element 20 projects slightly upwards relative to the housing seat 12 (see FIG. 10). In contrast, when the supporting base 10 moves towards the closing device 11, the insertion and extraction element 20 is inserted in a first half-chamber 21 made in a first part 22 of a containment body 23 described in more detail below; the first annular half-mould 13 is fixed to the first part 22 of the containment body 23.

According to this invention, the supporting base 10 and/or the closing device 11 also comprises one or more heating elements (not illustrated) for heating the first half-mould 13 and/or the second half-mould 14, for in use heating the annular band 2 and any covering film 8 placed on it. Advantageously, the heating elements are of the resistive type and are in themselves of the known type. Therefore, they are not described in detail). However, in the embodiment illustrated in the accompanying figures, the heating elements are only associated with the closing device 11.

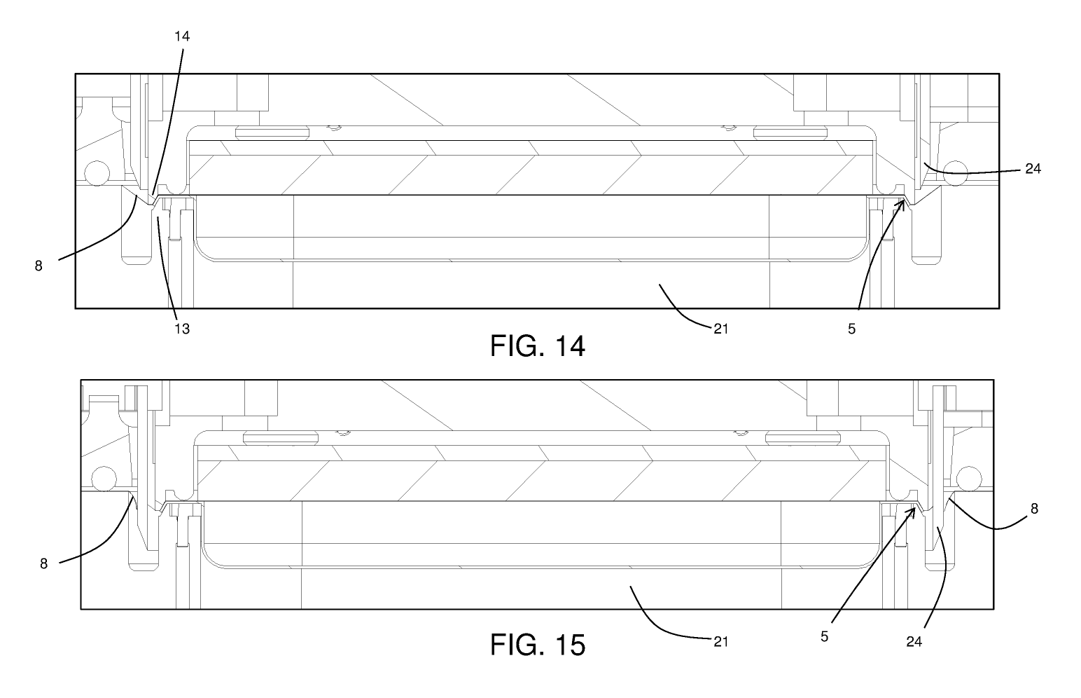

According to several preferred embodiments, as in the case illustrated in the accompanying figures, at least one of either the supporting base 10 or the closing device 11 also comprises at least one cutting element 24 that is positioned concentric with and on the outside of the first half-mould 13 or the second half-mould 14. That cutting element 24, which is advantageously an annular blade, is movable between a passive position in which it is retracted relative to a lying plane identified by the first half-mould 13 or respectively by the second half-mould 14, for in use not interfering with a covering film 8 and/or the annular band 2 which may be resting on the first half-mould 13 or respectively on the second half-mould 14 during the sealing step (FIG. 14), and an active position in which it projects relative to the lying plane identified by the first half-mould 13 or respectively by the second half-mould 14 for in use interfering with a covering film 8 resting on the first half-mould 13 or respectively on the second half-mould 14 and cutting it (FIG. 15).

In the case of the embodiments illustrated in FIGS. 17 to 19, the cutting element 24 is coaxial with the second body 30 and is advantageously moved from the passive position to the active position either when the second body 30 is moved from the non-operating position to the operating position (preferably, in this case, the cutting element 24 in the passive position is closer to the covering film 8 than the second body 30 in the non-operating position—FIGS. 17 and 19), or before that happens (however, advantageously after the closing of the mould—FIG. 18).

If the apparatus is able to perform both hot bending and sealing, in the preferred embodiment the apparatus is also designed in such a way that it can package products in a controlled atmosphere or in a vacuum.

For that purpose, in the embodiment illustrated the apparatus also comprises the containment body 23 internally forming a containment chamber and comprising a first part 22 and a second part 26. The first part 22 is part of the supporting base 10, whilst the second part 26 surrounds the closing device 11. The containment chamber corresponds to the joining of the first half-chamber 21 and a second half-chamber 27 formed by the second part 26.

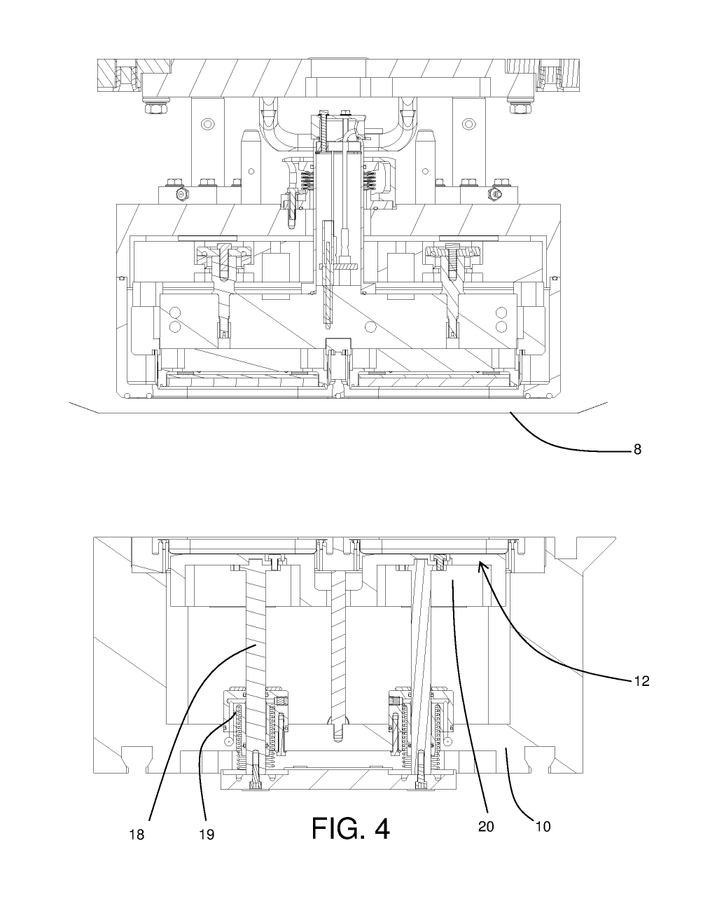

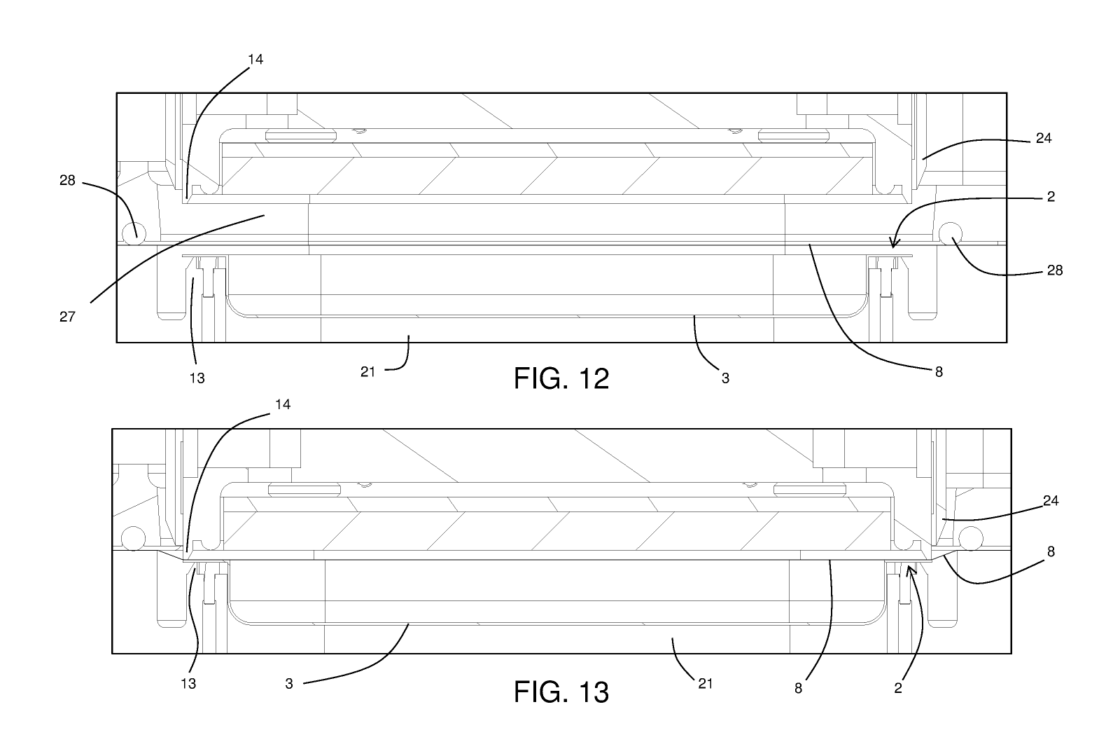

At least one of either the first part 22 or the second part 26 is movable relative to the other between an uncoupled position in which the first part 22 and the second part 26 are at a distance from each other and allow access to the containment chamber (FIG. 3), and a coupled position in which they are coupled in a fluidtight way by means of suitable gaskets 28 (FIGS. 4 and 12). In the coupled position, the housing seat 12, the closing device 11, the cutting element 24 and the annular mould are positioned in the containment chamber. A vacuum generating device (not illustrated) is connected to the containment chamber and is able to generate the vacuum in the containment chamber when the first part 22 and the second part 26 are in the coupled position.

If packaging in a controlled atmosphere is required, advantageously, connected to the containment chamber there will be a gaseous fluid feeding device (not illustrated) able to feed a gaseous fluid into the containment chamber when the first part 22 and the second part 26 are in the coupled position.

In the preferred embodiment, the first part 22 and the second part 26 are fixed respectively to the housing seat 12 and to the closing device 11 at least during the movement between the uncoupled position and the coupled position. Moreover, advantageously, when the first part 22 and the second part 26 are positioned in the coupled position, the housing seat 12 and/or the closing device 11 (only the latter in the embodiment illustrated) are also movable relative to one another between a back position in which a free space is present between the first half-mould 13 and the second half-mould 14, and a forward position in which the first half-mould 13 and the second half-mould 14 are coupled for clamping between them the annular band 2 and the covering film 8.

FIGS. 3 to 9, and the corresponding enlargements shown in FIGS. 10 to 16, schematically illustrate operation of the apparatus made according to the embodiment of this invention in which the apparatus itself is able to simultaneously perform both the hot bending step and the sealing step. In contrast, if the apparatus is intended to perform only the hot bending step, operation will be roughly the same as that described below without the parts relating to the sealing and/or packaging.

As shown in FIG. 3, with the first part 22 and the second part 26 in the uncoupled position, and consequently the supporting base 10 and the closing device 11 in the home position, at least one containment element 1 equipped with a flat annular band 2 can be positioned at the housing seat 12. However, the presence of the insertion and extraction element 20 keeps the containment element 1 outside the housing seat 12. At the same time the covering film 8 is held stationary above the containment element 1.

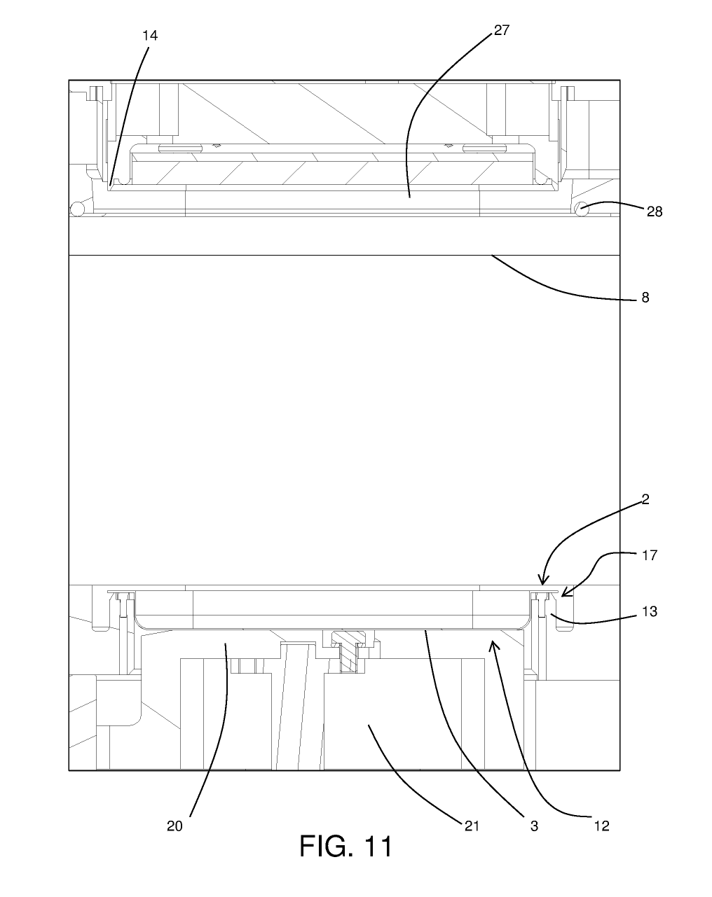

The supporting base 10 and the first part 22 of the containment body 23 then begin moving upwards, sliding along the guiding columns 18. Consequently, the insertion and extraction element 20 is gradually inserted in the first half-chamber 21 and the bottom wall 3 enters the housing seat 12 until the annular band 2 rests on the first half-mould 13 (FIG. 11).

The first part 22 of the containment body 23 then continues moving upwards until it makes contact against the second part 26, sealing the containment chamber in a fluidtight way. In this position (FIG. 12) the containment element 1 is positioned in the housing seat 12, the covering film 8 is retained between the first part 22 and the second part 26, and the closing device 11 is at a distance from the supporting base 10. The covering film 8 is still at a distance from the annular band 2 of the containment element 1.

In this configuration, by activating the vacuum generating device and, if necessary, subsequently the gaseous fluid feeding device, it is possible to create the vacuum or a controlled atmosphere in the containment chamber and therefore in the containment element 1 (in which the product to be packaged will be present) that is in fluid communication with the containment chamber.

When this operation has ended, the closing device 11 begin moving downwards towards the supporting base 10. During its movement, it rests first on the covering film 8 and pushes it downwards (slightly deforming it) until both rest on the annular band 2 (FIG. 13).

Thanks to the fact that at least one of either the first half-mould 13 or the second half-mould 14 is hot (the second half-mould 14 in the accompanying figures), from the moment of contact with it, the covering film 8 and the annular band 2 begin to be heat-sealed; the subsequent further downward movement of the closing device 11, until the supporting base 10 and the closing device 11 are in the operating position, completes sealing of the covering film 8 to the annular band 2 and causes hot bending of the annular band 2 (FIG. 14).

When this operation has ended, the cutting element 24 moves from the passive position to the active position and cuts to size the covering film 8 (FIG. 15) and if necessary also the annular band of the containment element 1.

At this point the process is complete and it is possible to return the supporting base 10 and the closing device 11 to the home position (and at the same time the first part 22 and the second part 26 to the uncoupled position). Towards the end of the movement, the insertion and extraction element 20 is inserted from below in the housing seat 12 and causes extraction of the sealed containment element 1. At the end of the movement the containment element 1 is therefore in the same position as at the start, but is sealed and has the annular band 2 modified to constitute the shaped flange 5 (FIG. 16).

This invention brings important advantages.

First, thanks to the idea of making all of the containment elements initially with a flat annular band, then shaping only the annular band and only if necessary, it guarantees a high degree of flexibility of choice in terms of the type of containment element to be used each time, even in the case of small-scale production where only one thermoforming line can be afforded.

Moreover, the fact that any shaping of the flange can be performed at the same time as sealing of the containment element allows the result to be achieved without increasing production costs and with extremely limited increases in terms of operating energy costs.

Finally, it should be noticed that this invention is relatively easy to produce and that even the cost linked to implementing the invention is not very high.

The invention described above may be modified and adapted in several ways without thereby departing from the scope of the inventive concept.

All details may be substituted with other technically equivalent elements and the materials used, as well as the shapes and dimensions of the various components, may vary according to requirements.

1. A method for making a containment element that has a bottom wall (3), a lateral wall (4) connected at the bottom to the bottom wall (3) and a shaped perimetric flange that extends outwards from an upper part of the lateral wall (4), wherein the method comprises:
an operating step of taking a flat sheet constituted of a thermoformable material;
a thermoforming operating step in which the flat sheet is thermoformed and the bottom wall (3), the lateral wall (4) and an annular band (2) that projects outwards from the upper part of the lateral wall (4) are created; and, subsequently
a hot bending operating step for bending the annular band (2), dividing the annular band (2) into a first annular portion (6) and a second annular portion (7) which are concentric and are not coplanar, after the hot bending the annular band (2) constituting the shaped perimetric flange.

2. The method according to claim 1, characterised in that it also comprises, after the thermoforming step, a positioning operating step for positioning a covering film (8) above the containment element (1) in such a way that a part of the covering film (8) rests on the annular band (2) at least for part of the outward extent of the annular band (2), relative to the upper part of the lateral wall (4); and in that the hot bending step comprises a heating step for heating the annular band (2) and the part of the covering film (8) positioned on the annular band (2), a step of heat-sealing the covering film (8) to the annular band (2), and a step of hot bending the annular band (2).

3. The method according to claim 2, characterised in that the hot bending step is performed after the heat-sealing step, simultaneously with the heat-sealing step or before the heat-sealing step.

4. The method according to claim 2, characterised in that it also comprises, after the thermoforming and heat-sealing steps, a step of cutting the covering film (8) along a profile that surrounds the annular band (2).

5. The method according to claim 4, characterised in that the step of cutting the covering film (8) is performed before or after the hot bending step.

6. A method for packaging products comprising the operating steps of making a containment element (1) according to claim 1 and of positioning the product in the containment element (1) after the thermoforming operating step and before the hot bending operating step.

7. The method according to claim 6, characterised in that it also comprises, after the thermoforming step, a positioning operating step for positioning a covering film (8) above the containment element (1) in such a way that a part of the covering film (8) rests on the annular band (2) at least for part of the outward extent of the annular band (2), relative to the upper part of the lateral wall (4); in that the hot bending step comprises a heating step for heating the annular band (2) and the part of the covering film (8) positioned on the annular band (2), a step of heat-sealing the covering film (8) to the annular band (2), and a step of hot bending the annular band (2); and in that it also comprises an operating step of creating a modified atmosphere inside the containment element (1) before the hot bending operating step.

8. An apparatus for heat-sealing a covering film (8) to an annular band (2) of a containment element (1), wherein the containment element (1) has a bottom wall (3) and a lateral wall (4) connected at the bottom to the bottom wall (3), the annular band (2) extending outwards from an upper part of the lateral wall (4), the apparatus comprising:
a supporting base (10) that comprises a housing seat (12) suitable for in use housing the bottom wall (3) and the lateral wall (4) of a containment element (1), and a first half-mould (13) that has an annular shape and that surrounds the housing seat (12) and is suitable for in use supporting the annular band (2);
a closing device (11) positioned above the supporting base (10), the closing device (11) comprising at least a second half-mould (14) that has an annular shape and that is shaped to match the first half-mould (13);
and a retaining device operatively associated with the supporting base (10) and with the closing device (11) and suitable for in use retaining a closing film (8) between the first half-mould (13) and the second half-mould (14);
wherein
at least one of either the supporting base (10) or the closing device (11) is movable relative to the other between a home position in which the two are at a distance from one another, and an operating position in which the first half-mould (13) and the second half-mould (14) are coupled and define an annular mould suitable for in use clamping the annular band (2);
at least one of either the first half-mould (13) or the second half-mould (14) has a moulding surface (15) that comprises at least a first annular zone (16) that in the operating position surrounds the housing seat (12) and a second annular zone (17) concentric with and adjacent to the first annular portion (6), the first annular zone (16) and the second annular zone (17) not being coplanar; and
the supporting base (10) and/or the closing device (11) also comprising one or more heating elements for heating either only the first half-mould (13) or only the second half-mould (14) or both for in use heating the annular band (2) and the covering film (8) placed on it.

9. The apparatus according to claim 8, wherein the supporting base (10) or respectively the closing device (11) also comprise at least one cutting element (24) that is positioned concentric with and on the outside of the first half-mould (13) or respectively the second half-mould (14), and that is movable between a passive position in which it is retracted relative to a lying plane identified by the first half-mould (13) or respectively by the second half-mould (14), for in use not interfering with a covering film (8) resting on the first half-mould (13) or respectively on the second half-mould (14), and an active position in which it projects relative to the lying plane identified by the first half-mould (13) or respectively by the second half-mould (14) for in use interfering with a covering film (8) resting on the first half-mould (13) or respectively on the second half-mould (14).

10. The apparatus according to claim 8, wherein at least one of either the first half-mould (13) or the second half-mould (14) comprises a first body (29) and a second body (30) that are annular and concentric, wherein the second body (30) is telescopically movable relative to the first body (29) between a non-operating position and an operating position, and wherein when the second body (30) is in the operating position the first half-mould (13) and the second half-mould (14) are couplable and can constitute the annular mould, and when the second body (30) is in the non-operating position the first half-mould (13) and the second half-mould (14) cannot fully constitute the annular mould.

11. The apparatus according to claim 8, wherein the first body (29) and the second body (30) are part of the second half-mould (14), wherein the first body (29) is mounted on the inside relative to the second body (30), and wherein the second body (30) is retracted relative to a resting surface defined by the first body (29) when it is in the non-operating position, and projects relative to it when it is in the operating position.

12. The apparatus according to claim 8, wherein the supporting base (10) also comprises an insertion and extraction element (20) associated with the housing seat (12), at least one of either the housing seat (12) or the insertion and extraction element (20) being movable relative to the other between an engaged position, in which the insertion and extraction element (20) prevents the insertion of a containment element (1) in the housing seat (12), and a disengaged position, in which the insertion and extraction element (20) allows the insertion of a containment element (1) in the housing seat (12).

13. The apparatus according to claim 8, also comprising:
a containment body (23) that internally defines a containment chamber and that comprises a first part (22) and a second part (26) movable between an uncoupled position in which they are at a distance from each other and allow access to the containment chamber, and a coupled position in which they are coupled in a fluidtight way and they contain at least the housing seat (12), the closing device (11) and the annular mould;
a vacuum generating device connected to the containment chamber and able to generate the vacuum in the containment chamber when the first part (22) and the second part (26) are in the coupled position; and
a gaseous fluid feeding device connected to the containment chamber and able to feed a gaseous fluid into the containment chamber when the first part (22) and the second part (26) are in the coupled position.

14. The apparatus according to claim 13, wherein the first part (22) and the second part (26) are fixed respectively to the housing seat (12) and to the closing device (11) at least during the movement between the uncoupled position and the coupled position, and in that the housing seat (12) and/or the closing device (11) are also movable respectively relative to the first part (22) and to the second part (26) positioned in the coupled position, between a back position in which a free space is present between the first half-mould (13) and the second half-mould (14), and a forward position in which the first half-mould (13) and the second half-mould (14) are coupled.

15. A thermoforming machine comprising a thermoforming station suitable for in use thermoforming a containment element (1) that has a bottom wall (3) and a lateral wall (4) connected at the bottom to the bottom wall (3) and an annular band (2) that extends outwards from an upper part of the lateral wall (4), and an apparatus with optional activation, positioned downstream of the thermoforming station and comprising:
a supporting base (10) that in turn comprises a housing seat (12) suitable for in use housing the bottom wall (3) and the lateral wall (4) of a containment element (1), and a first half-mould (13) that has an annular shape and that surrounds the housing seat (12) and is suitable for in use supporting the annular band (2);
a closing device (11) positioned above the supporting base (10), the closing device (11) comprising at least a second half-mould (14) that has an annular shape and that is shaped to match the first half-mould (13);
at least one of either the supporting base (10) or the closing device (11) being movable relative to the other between a home position in which the two are at a distance from one another, and an operating position in which the first half-mould (13) and the second half-mould (14) are coupled and define an annular mould suitable for in use clamping the annular band (2);
at least one of either the first half-mould (13) or the second half-mould (14) having a moulding surface (15) that comprises at least a first annular zone (16) that in the operating position surrounds the housing seat (12) and a second annular zone (17) concentric with and adjacent to the first annular zone (16), the first annular zone (16) and the second annular zone (17) not being coplanar; and
the supporting base (10) and/or the closing device (11) also comprising one or more heating elements for heating either only the first half-mould (13) or only the second half-mould (14) or both for in use heating the annular band (2).

16. The machine according to claim 15, wherein the supporting base (10) or respectively the closing device (11) also comprise at least one cutting element (24) that is positioned concentric with and on the outside of the first half-mould (13) or respectively the second half-mould (14), and that is movable between a passive position in which it is retracted relative to a lying plane identified by the first half-mould (13) or respectively by the second half-mould (14), for in use not interfering with the annular band (2) resting on the first half-mould (13) or respectively on the second half-mould (14), and an active position in which it projects relative to the lying plane identified by the first half-mould (13) or respectively by the second half-mould (14) for in use interfering with the annular band (2) resting on the first half-mould (13) or respectively on the second half-mould (14).

17. The machine according to claim 15, wherein the supporting base (10) also comprises an insertion and extraction element (20) associated with the housing seat (12), at least one of either the housing seat (12) or the insertion and extraction element (20) being movable relative to the other between an engaged position, in which the insertion and extraction element (20) prevents the insertion of a containment element (1) in the housing seat (12), and a disengaged position, in which the insertion and extraction element (20) allows the insertion of a containment element (1) in the housing seat (12).
